(19) United States
(12) Patent Application Publication
(10) Pub. No.: US 2011/0035466 A1
(43) Pub. Date: Feb. 10, 2011

(54) HOME MEDIA AGGREGATOR SYSTEM AND METHOD

(75) Inventor: Biswaranjan Panigrahi, Bangalore (IN)

Correspondence Address: INGRASSIA FISHER & LORENZ, P.C. (EchoStar), 7010 E. COCHISE ROAD, SCOTTSDALE, AZ, 85253, US

(73) Assignee: SLING MEDIA PVT LTD, Bangalore (IN)

(21) Appl. No.: 12/538,681

(22) Filed: Aug. 10, 2009

(51) Int. Cl. G06F 15/16

(52) U.S. Cl. 709/219

(57) ABSTRACT

Systems and methods are described for aggregating and playing media content using a proxy server. A request is received, in the proxy server, to play media content from a placeshifting media source on a media player. The requested media content is received, in the proxy server, from the placeshifting media source. The proxy server determines the media playing capability of the media player, and transmits the requested media content to the media player in a manner that is compatible with the media player associated with the request.

### TECHNICAL FIELD

The present disclosure generally relates to techniques for transmitting media content to a plurality of different media devices so that one or more users may experience the transmitted media content on the plurality of different media devices.

### BACKGROUND

Recently, consumers have expressed significant interest in “placeshifting” devices that allow users to view, and/or listen to, various media content at locations other than a primary media player. For example, a placeshifting device may allow a user to view television content at a location other than that of their primary television set. Placeshifting devices typically packetize media content that can be transmitted over a local or wide area network to a portable computer, mobile phone, personal digital assistant, remote television or other remote device capable of playing back the packetized media stream. Placeshifting therefore allows consumers to experience media content from remote locations such as other rooms, hotels, offices, and/or any other locations where portable media player devices can gain access to a wireless or other communications network.

While placeshifting does greatly improve user convenience, various drawbacks presently exist. Specifically, present systems do not allow multiple users, in the same communications network, to simultaneously play different content using different remote devices. That is, users associated with the same communication network are constrained to play the same media content, albeit in different locations.

It is therefore desirable to create systems and methods for transmitting different media content to a plurality of different media devices on the same network so that one or more users may experience different media content on the plurality of different media devices and at different locations. These and other desirable features and characteristics will become apparent from the subsequent detailed description and the appended claims, taken in conjunction with the accompanying drawings and this background section.

### BRIEF SUMMARY

In an exemplary method, Capability information for each of a plurality of media players of a placeshifting system is stored in a proxy server. The capability information comprises data representative of media playing capabilities of each of the plurality of media players. A request is received, by a proxy server, to play media content from a media source on one of the plurality of media players. The requested media content is received, by the proxy server, from the requested media source. The proxy server determines the media playing capability of the media player associated with the request from its corresponding capability information. The requested media content is transmitted from the proxy server to the media player associated with the request in a manner consistent with the media playing capability of the media player associated with the request.

In another exemplary embodiment, a proxy server includes memory and a processing device. The memory has stored therein media source capability information for each of a plurality of media sources, and media player capability information for each of a plurality of media players. The media player capability information including data representative of the media playing capabilities of each media player. The processing device is in operable communication with the memory and is configured to selectively communicate with one or more of the plurality of media players via a network, and to selectively receive media content from one or more of the plurality of media sources. The processing device is adapted to receive a request for media content that is stored on one of the media sources to be played on one of the plurality of media players, and is further configured, in response to the request, to receive the requested for media content from the media source, determine the media playing capability of the media player associated with the request from its media player capability information, and transmit the requested for media content to the media player associated with the request in a manner that is compatible with the media player associated with the request.

In yet another exemplary embodiment, a proxy server includes memory and a processing device. The memory has stored therein media source capability information for each of a plurality of media sources, and media player capability information for each of a plurality of media players. The media player capability information includes data representative of the media playing capabilities of each media player. The processing device is in operable communication with the memory and is configured to selectively communicate with one or more of the plurality of media players via a network and to selectively receive media content from one or more of the plurality of media sources. The processing device is adapted to receive a first request for media content that is stored on a first one of the media sources to be played on a first one of the plurality of media players and a second request for media content that is stored on a second one of the media sources to be played on a second one of the plurality of media players. The processing device is further configured, in response to the requests, to receive the media content associated with the first request from the first one of the media sources, receive the media content associated with the second request from the second one of the media sources, determine the media playing capability of the media player associated with the first request from its media player capability information, determine the media playing capability of the media player associated with the second request from its media player capability information, transmit the requested for media content to the media player associated with the first request in a manner that is compatible with the media player associated with the first request, and simultaneously transmit the requested for media content to the media player associated with the second request in a manner that is compatible with the media player associated with the second request.

Furthermore, other desirable features and characteristics of the media aggregator system and method will become apparent from the subsequent detailed description and the appended claims, taken in conjunction with the accompanying drawings and the preceding background.

### BRIEF DESCRIPTION OF THE DRAWING FIGURES

Exemplary embodiments will hereinafter be described in conjunction with the following drawing figures, wherein like numerals denote like elements, and wherein:

FIG. 1 is a block diagram of an exemplary media aggregator system;

FIG. 2 is a flowchart of an exemplary process for playing media content on a media player; and

FIG. 3 is a flowchart of an exemplary process for playing media content from one media player on another media player.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

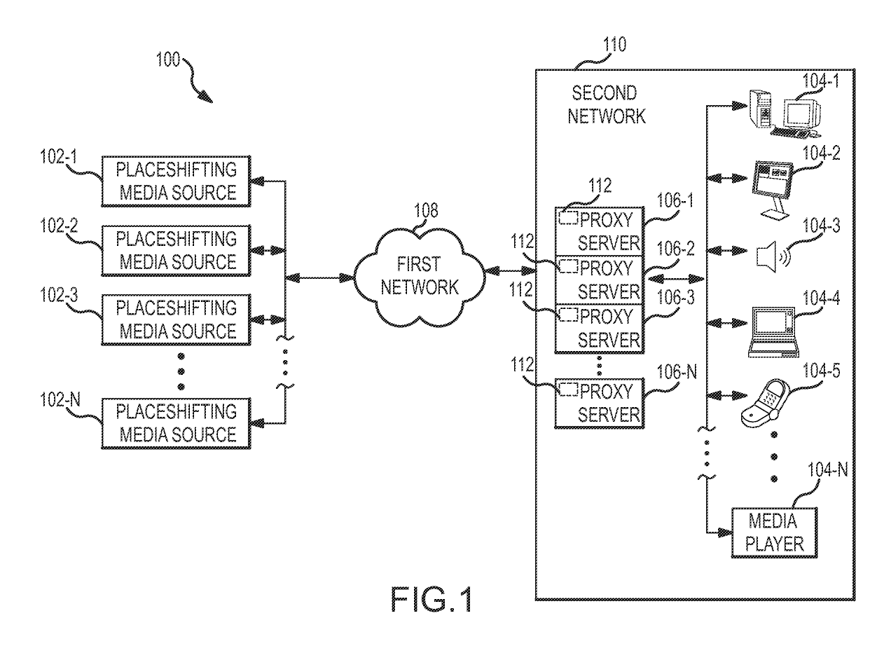

Turning now to the drawing figures and with initial reference to FIG. 1, an exemplary system 100 suitably includes one or more media sources 102 of placeshifting systems, a plurality of media players 104 (104-1, 104-2, 104-3, . . . 104-N), one or more proxy servers 106, and two networks—a first network 108 and a second network 110. The media sources 102 are in operable communication with a first network 108 and are connected to receive media content from one or more other media sources and/or are an originating source of media content. In any case, the media sources 102 encode media content into a streaming format for transmission over the first network 108.

The media sources 102 may be implemented using any one of numerous components, hardware, software logic and/or the like capable of transmitting a packetized stream of media content over the first network 108. In various embodiments, a media source 102 incorporates suitable encoder and/or transcoder (collectively “encoder”) logic to convert audio/video or other media data into a packetized format that can be transmitted over the first network 108. Several examples of media soruces 102 include any of the various SLINGBOX products available from Sling Media of Foster City, Calif., although other products could be used in other embodiments. Other examples of media sources 102 include media sources such as, for example, Sling.com or YouTube, or any other network enabled system or device that implements placeshifting functionality. Although the media sources 102 are depicted in FIG. 1 as comprising the first network 108, it will be appreciated that one or more of the media sources 102 could comprise the second network 110, or one or more other non-illustrated networks.

The media players 104 are configured to selectively receive and media content. The media players 104 may be any one of numerous suitable devices, components, modules, hardware, software and/or the like capable of receiving and playing media content. Some non-limiting examples of suitable media players include personal computers (e.g., a “laptop” or similarly portable computer, although desktop-type computers could also be used), mobile phones, personal digital assistants, personal media players (such as the ARCHOS products available from the Archos company of Igny, France), various standalone media players (e.g., the SLINGCATCHER product available from Sling Media of Foster City, Calif., or equivalent) or the like. In some embodiments, one or more of the media players 104 may be a general purpose computing device that includes a media player application in software or firmware that is capable of securely connecting to the one or more proxy servers 106, as described more fully below, and of receiving and playing media content. One or more of the media players 104 may also be conventional television sets and/or conventional display devices. No matter the specific type or number of media players 104, each is, or is at least adapted to be, in operable communication with the one or more proxy servers 106. Moreover, although the media players 104 are depicted in FIG. 1 as being in operable communication with the proxy servers 106 via the second network lo, it will be appreciated that one or more of the media players 104 could be in operable communication with the proxy servers 106 via the first network 108, or one or more other non-illustrated networks.

The first and second networks 108, 110 are each any digital or other communications network capable of transmitting messages between sender devices and receiver devices. In various embodiments, the first and second networks 108, lo may include any number of public or private data connections, links or networks supporting any number of communications protocols. The first network 108, however, preferably includes the Internet or any other suitable network based upon TCP/IP or other conventional protocols. In various embodiments, the second network lo may include a wireless and/or wired telephone network, such as a cellular communications network for communicating with mobile phones, personal digital assistants, and/or the like. In a preferred embodiment, however, the second network lo is implemented using any one of numerous wireless or wired local area networks (LAN)/wide area networks (WAN), such as one or more IEEE 802.3 and/or IEEE 802.11 networks, or equivalents.

Each of the one or more proxy servers 106 is in operable communication with the first and second networks 108, 110. The proxy servers 106 preferably include one or more processing devices (e.g., one or more processors or other suitable devices) and a plurality of different types audio and video ports such as, for example, composite video, S-video, component video, and HDMI, just to name a few. In this regard, the proxy servers 106 may be in operable communication with a media player 104 via the second network lo, which as noted above may be wired or wireless, or via one of the ports, as needed or desired. The proxy servers 106 additionally include suitable storage media 112 for storing various media content and/or other information. In this regard, the proxy servers 106 may also be seen to function as media aggregators. The proxy servers 106 may also independently function as media sources. The media content stored on the storage media 112 may be supplied from one or more of the sources 102 or from a non-illustrated external system. The proxy servers 106 may thus be used to store media content that a user has purchased from various content providers (e.g., sling.com), and to build video libraries, which may then be watched on one or more of the media players 104. As will be described further below, the media content stored on the storage media 112 may be supplied from one or more of the media players 104.

The proxy servers 106 are also configured to store registration information associated with each of the media sources 102 and each of the media players 104. The registration information may be transmitted to the proxy servers 106 from the media sources 102, the media players 104, or from a separate stand-alone device or system. Alternatively, the proxy servers may retrieve the registration information from the media sources 102 and media players 104, either automatically or in response to a prompt. In any case, the stored registration information uniquely identifies each of the media sources 102 and each of the media players 104, and includes data representative of their associated capabilities. More specifically, the media source registration information associated with each media source 102 includes data representative of, for example, its media content transmission/receipt capability. Similarly, the media player registration information associated with each media player 104 includes data representative of, for example, its media playing capabilities.

As will be described further below, the proxy servers 106 use the capability data to determine whether to transrate/transcode media content before transmitting it over the first or second network 108, 110. In this regard, it will be appreciated that the proxy servers 106 are also configured with suitable transrate/transcode devices and/or software, to implement this functionality. It will additionally be appreciated that media content receipt and transmission between the proxy servers 106 and media sources 102, and between the proxy servers and media players 104, takes place only with registered media sources and registered media players 104.

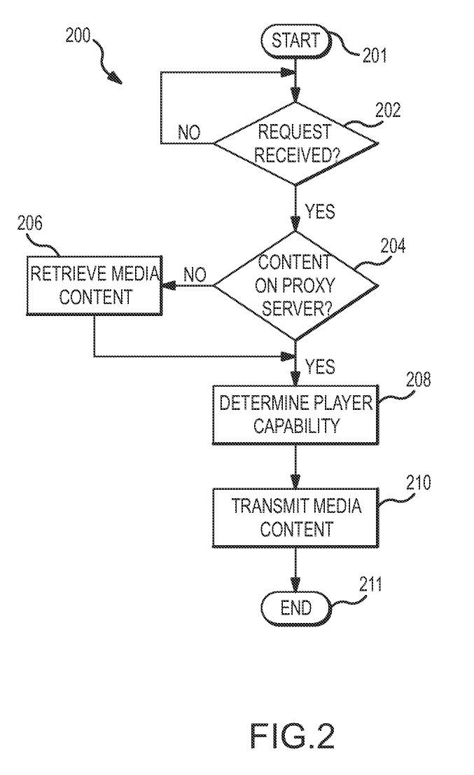

The system 100 implements various processes for aggregating and playing media content. One exemplary process 200 is depicted in flowchart form in FIG. 2, and with reference thereto will now be described. It is noted that the depicted process 200 is exemplary of a session between a proxy server 106 and one or more media players 104 when it is desired to play media on one or more media players. It is additionally noted that in the proceeding descriptions, the parenthetical numerical references refer to like numbered blocks in the depicted flowcharts.

A session between a proxy server 106 and a media player 104 is initiated when the proxy server 106 receives a request to play media content from one of the registered media sources 102 on one of the registered media players 104 (202). It will be appreciated that the request may be supplied from the registered media player 104 or from an external system or device (e.g., a remote control). Upon receipt of the request, the proxy server 106 first determines if the requested media content has been previously retrieved from the registered media source 102 and stored on the storage media 112 (204). If not, the proxy server 106 retrieves the requested media content from the registered media source 102 (206).

Before transmitting the requested for media content, the proxy server 106 determines the media playing capability of the registered media player 104 associated with the request (208). For example, the proxy server 106 determines whether it needs to transrate/transcode the media content before transmission. As noted above, the media playing capability of each registered media player 104 is included in its registration information. Thus, the proxy server 106 determines the media playing capability of the registered media player 104 associated with the request from its registration information. The proxy server 106 will then transmit the requested media content to the registered media player 104 associated with the request, and do so in a manner that is compatible with the registered media player 104 (210). For example, the media content may be transmitted at a bitrate and/or in a format that is compatible with the registered media player 104.

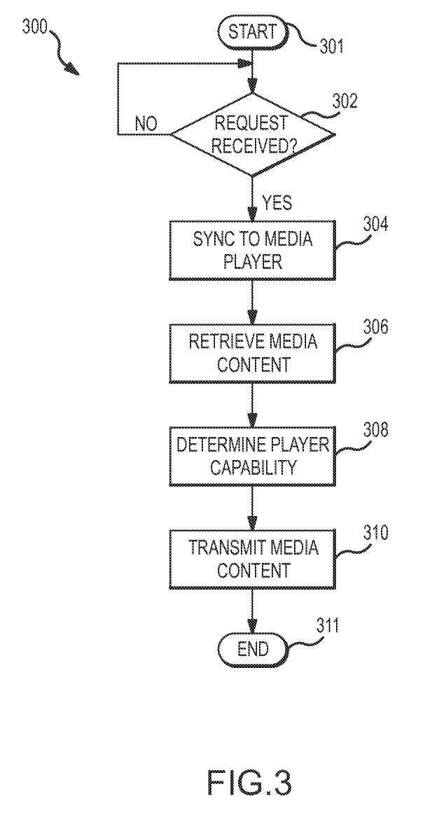

In addition to the process 200 described above, the proxy servers 106 may also sync to one or more registered media players 104 and, if a user requests, access media content that may be stored/hosted on the one or more registered media players 104, and allow the accessed media content to be played on one or more other registered media players 104. An exemplary embodiment the manner in which this process is implemented in the system 100 is depicted in FIG. 3 in flowchart form, and with reference thereto will now be described.

The above-described process 300 is initiated when the proxy server 106 receives a request to play media content from one of the registered media players 104 on another one of the registered media players 104 (302). This request may also be supplied from a registered media player 104 or from an external system or device (e.g., a remote control). Upon receipt of the request, the proxy server 106 syncs to the registered media player 104 having the requested media content stored thereon (304), and retrieves the requested media content from the registered media player (306).

Again, before transmitting the requested for media content to the registered media player 104 on which the media content is to be played, the proxy server 106 determines its media playing capability (308). The proxy server 106 then transmits the requested media content to the registered media player 104 associated with the request, and does so in a manner (e.g., at a bitrate and/or in a format) that is compatible with the registered media player 104 (310).

Whether transmitting media content that originates from a registered media source 102 or from a registered media player 104, the proxy servers 106 are configured to operate in a plurality of modes. These modes include what are referred to herein as a “Live” mode and a “Trickle” mode. In the Live mode there is minimal buffering in the proxy server 106, and thus a registered media player 104 plays the media content at least substantially simultaneously upon receipt thereof in the proxy server 106. In the Trickle mode, a user may configure the proxy server 106 establish communications with a particular registered media source 102 at a particular time, and receive and stored specified media content on the storage media 112.

In addition to receiving media content from registered media sources 102, the proxy servers 106 may also be configured to upload media content to one or more of the media sources 102. A user may configure the time and manner in which the proxy servers 106 upload media content to one or more media sources 102. The media content may be uploaded to the selected media sources 102 immediately, or whenever the selected media sources 102 are in an idle state.

Because the proxy sever 106 is, at least in some embodiments, acting as a media gateway, it may also, in some embodiments, implement additional functionality. For example, the proxy server 106 may be configured to learn the particular type and/or nature of media content that is being played on a media player 104 with respect to time. Based on this, the proxy server 106 may provide ratings for the media content being stored on the storage media 112. These same ratings may also be used to categorize media content in one or more of the media sources 102. Additionally, the proxy servers 106 may use the ratings to recommend media content to a user.

With the proxy server 106 disclosed herein, each of the registered media players 104 is agnostic to each of the registered media sources 102. The streaming quality on low bandwidth internet connections will be relatively better than presently known configurations. The same content can be watched on any type of registered media player 104 that is in operable communication with the proxy server(s) 106. Moreover, the proxy server 106 allows different registered media players 104 in the second network to simultaneously play different media content.

The term “exemplary” is used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method comprising:
storing capability information for each of a plurality of media players of a placeshifting system in a proxy server, the capability information comprising data representative of media playing capabilities of each of the plurality of media players;
receiving, by the proxy server, a request to play media content from a media source of a placeshifting media system on one of the plurality of media players;
receiving, by the proxy server, the requested media content from the requested media source;
determining, using the proxy server, media playing capability of the media player associated with the request from its corresponding capability information; and
transmitting the requested media content from the proxy server to the media player associated with the request in a manner consistent with the media playing capability of the media player associated with the request.

2. The method of claim 1, further comprising:
receiving, by the proxy server, a request to play, on a first one of the media players, media content that is stored on a second one of the plurality of media players;
retrieving, by the proxy server, the requested media content from the second one of the media players; and
transmitting the retrieved media content from the proxy server to the first one of the media players in a manner that is compatible with the first one of the media players.

3. The method of claim 1, wherein:
each media player is in operable communication with the proxy server via a network; and
communications between the proxy server and each media player occur via the network.

4. The method of claim 1, further comprising:
selectively receiving and storing, in the proxy server, media content from a media source.

5. The method of claim 4, further comprising:
receiving, in the proxy server, a request for media content stored in the proxy server to play media on one of the plurality of media players; and
transmitting the requested for media content that is stored in the proxy server from the proxy server to the media player associated with the request in a manner that is compatible with the media player associated with the request.

6. The method of claim 1, wherein the requested media content is transmitted from the proxy server to the media player substantially simultaneously upon receipt thereof, from the media source, by the proxy server.

7. The method of claim 1, wherein the request for media content includes data representative of a specified time, and wherein the method further comprises:
establishing communication with the media source at the specified time; and
receiving, by the proxy server, the requested for media content from the media source.

8. The method of claim 1, further comprising:
simultaneously transmitting the requested for media content from the proxy server to one or more additional media players.

9. The method of claim 8, further comprising:
simultaneously transmitting other media content from the proxy server to one or more other media players.

10. The method of claim 1, wherein the capability information for each of the plurality of media players comprises bitrate information.

11. The method of claim 1, wherein the capability information for each of the plurality of media players comprises media format information.

12. The method of claim 1, further comprising:
storing media source capability information for each of the plurality of media sources in a proxy server.

13. A proxy server, comprising:
memory having stored therein (i) media source capability information for each of a plurality of media sources and (ii) media player capability information for each of a plurality of media players, the media player capability information including data representative of the media playing capabilities of each media player,
a processing device in operable communication with the memory and configured to selectively communicate with one or more of the plurality of media players via a network and to selectively receive media content from one or more of the plurality of media sources, the processing device adapted to receive a request for media content that is stored on one of the media sources to be played on one of the plurality of media players, and further configured, in response to the request, to:
(i) receive the requested for media content from the media source,
(ii) determine the media playing capability of the media player associated with the request from its media player capability information, and
(iii) transmit the requested for media content to the media player associated with the request in a manner that is compatible with the media player associated with the request.

14. The proxy server of claim 13, wherein the processing device is:
further adapted to receive a request for media content that is stored on a first one of the media players to be played on a second one of the plurality of media players; and
further configured, in response to the request for media that is stored on the first one of the media players, to (i) retrieve the requested for media content from the first one of the media players and (ii) transmit the retrieved media content to the second one of the media players in a manner that is compatible with the second one of the media players.

15. The proxy server of claim 13, wherein the processing device is further configured to selectively receive and store therein media content from each of the plurality of media sources.

16. The proxy server of claim 15, wherein the processing device is:
further adapted to receive a request for media content stored in the proxy server to be played on at least one of the plurality of media players; and
further configured, in response to the request for media content stored therein, to transmit the requested for media content to the media player associated with the request in a manner that is compatible with the at least one media player associated with the request.

17. The proxy server of claim 13, wherein processing device is further configured to selectively transmit the requested for media content to the media player substantially simultaneously upon its receipt, from the media source, of the requested for media content.

18. The proxy server of claim 13, wherein the processing device is further configured to simultaneously transmit other media content to one or more other registered media players.

19. A proxy server, comprising:
memory having stored therein (i) media source capability information for each of a plurality of media sources and (ii) media player capability information for each of a plurality of media players, the media player capability information including data representative of the media playing capabilities of each media player,
a processing device in operable communication with the memory and configured to selectively communicate with one or more of the plurality of media players via a network and to selectively receive media content from one or more of the plurality of media sources, the processing device adapted to receive a first request for media content that is stored on a first one of the media sources to be played on a first one of the plurality of media players and a second request for media content that is stored on a second one of the media sources to be played on a second one of the plurality of media players, and further configured, in response to the request, to:
(i) receive the media content associated with the first request from the first one of the media sources,
(ii) receive the media content associated with the second request from the second one of the media sources,
(iii) determine the media playing capability of the media player associated with the first request from its media player capability information,
(iv) determine the media playing capability of the media player associated with the second request from its media player capability information,
(v) transmit the requested for media content to the media player associated with the first request in a manner that is compatible with the media player associated with the first request, and
(vi) simultaneously transmit the requested for media content to the media player associated with the second request in a manner that is compatible with the media player associated with the second request.
